(19) United States
(12) Patent Application Publication
(10) Pub. No.: US 2025/0230304 A1
(43) Pub. Date: Jul. 17, 2025

(54) RUBBER COMPOSITION FOR TIRE TREAD AND TIRE

(71) Applicant: Toyo Tire Corporation, Itami-shi (JP)

(72) Inventor: Gouya Ichinose, Itami-shi (JP)

(73) Assignee: Toyo Tire Corporation, Itami-shi (JP)

(21) Appl. No.: 18/990,057

(22) Filed: Dec. 20, 2024

(30) Foreign Application Priority Data
Jan. 16, 2024 (JP) 2024-004552

(51) Int. Cl. C08L 15/00; B60C 1/00; B60C 11/00; C08L 9/00

(52) U.S. Cl. CPC C08L 15/00; B60C 1/0016; B60C 11/0008; C08L 9/00; B60C 2011/0025; C08L 2205/025; C08L 2205/035; C08L 2207/04

(57) ABSTRACT

The rubber composition for a tire tread according to the embodiment contains a diene rubber component, a thermoplastic elastomer, a resin, and silica. The diene rubber component has a total styrene amount of less than 10 mass %. The thermoplastic elastomer is at least one selected from the group consisting of a block copolymer of a styrene-based monomer and a diene monomer and a hydrogenated material thereof and has a butylene unit content of 25 mass % or less based on the total mass of the ethylene unit and the butylene unit. The resin is at least one selected from the group consisting of a styrene-based resin and a hydrogenated petroleum resin. The amount of the thermoplastic elastomer is 1 to 10 parts by mass based on 100 parts by mass of the diene rubber component.

### BACKGROUND OF THE INVENTION

### 1. Field of the Invention

The present invention relates to a rubber composition for a tire tread and a tire using the same.

### 2. Description of Related Art

To achieve low fuel efficiency during driving of a vehicle, a decrease in rolling resistance of tires, namely improvement of rolling resistance performance, has been recently required. Moreover, in view of safety, improvement of wet performance, which is driving performance on a wet road surface at normal temperature, is required. Furthermore, improvement of snow performance, which is driving performance on a snowy road, is also required for winter tires and all-season tires in addition to the above performances.

As techniques for improving the wet performance, for example, JP2023-087363A discloses that wet grip performance and driving stability after aging can be improved by adding a specific amount of silica and a resin such as C5-based resin to a rubber component containing a butadiene rubber and by specifying a polymer amount/an acetone extraction amount. JP2023-087363A discloses that a styrene-based thermoplastic elastomer may be further added.

JP2021-167401A discloses that C5-based resin and/or C5-C9-based resin and an aromatic vinyl polymer such as an aromatic vinyl thermoplastic elastomer are added to rubber components containing an isoprene-based rubber and a styrene butadiene-based rubber and that wet grip performance during high-speed driving is thus improved.

JP2018-095762A discloses that a thermoplastic elastomer showing a tanδ peak value in the range of −20 to 20° C. and having a peak value thereof of 1 or more is added to a rubber component containing a specific amount of a solution-polymerized styrene butadiene rubber and that wet performance, and fatigue resistance and tearing force resistance are thus improved with a good balance. JP2018-095762A discloses that a tackifying resin having a softening point of 90 to 160° C. may be further added.

WO2019/117093A1 discloses that a styrene-alkylene block copolymer having a total styrene unit content of 30 mass % or more and a filler having a CTAB adsorption specific surface area of 110 m²/g or less are added to a rubber component and that low loss property of tires, wet performance, and dry handling property are thus well balanced. In WO2019/117093A1, the styrene-alkylene block copolymer used has a butylene unit content of 41 mass % or more based on the total mass of the butylene unit and the ethylene unit.

### SUMMARY OF THE INVENTION

Of the rolling resistance performance, the wet performance, and the snow performance, the rolling resistance performance and the snow performance can be improved by adding a diene rubber having a low glass transition temperature to the rubber component constituting a tread of a tire. When the composition is designed using a diene rubber having a low glass transition temperature, however, it is difficult to secure satisfactory wet performance. Accordingly, there is a problem of the difficulty in obtaining all the performances with a good balance.

In view of the above point, an object of the embodiment of the invention is to provide a rubber composition for a tire tread which can solve the issue that wet performance, rolling resistance performance, and snow performance conflict with each other, namely improve the balance of the performances, and to provide a tire using the same.

Here, JP2023-087363A, JP2021-167401A, and JP2018-095762A disclose that silica, a thermoplastic elastomer, and a resin are added to a rubber component containing a styrene butadiene rubber but do not disclose that the balance of the wet performance, the rolling resistance performance, and the snow performance is improved in a composition in which the total styrene amount of the rubber component is less than 10 mass %. Moreover, WO2019/117093A1 merely discloses a copolymer having a high butylene unit content as the styrene-alkylene block copolymer as the thermoplastic elastomer and does not disclose that a copolymer having a butylene unit content of 25 mass % or less is used.

The invention includes the embodiments shown below.

[1] A rubber composition for a tire tread, containing:
a diene rubber component having a total styrene amount of less than 10 mass %;
at least one thermoplastic elastomer selected from the group consisting of a block copolymer of a styrene-based monomer and a diene monomer and a hydrogenated material thereof, wherein the amount of a butylene unit represented by —[CH₂—CH(C₂H₅)]— is 25 mass % or less based on the total mass of an ethylene unit represented by —(CH₂—CH₂)— and the butylene unit;
at least one resin selected from the group consisting of a styrene-based resin and a hydrogenated petroleum resin; and
silica:
wherein the amount of the thermoplastic elastomer based on 100 parts by mass of the diene rubber component is 1 to 10 parts by mass.

[2] The rubber composition for a tire tread according to [1], wherein the diene rubber component contains a styrene butadiene rubber.

[3] The rubber composition for a tire tread according to [1] or [2], wherein the peak temperature of the diene rubber component is −20° C. or lower in a tanδ-temperature curve of the rubber composition which has been vulcanized obtained by a dynamic viscoelasticity test by a tension method with a frequency of 10 Hz, a static strain of 10%, and a strain amplitude of 0.2% in accordance with JIS K6394:2007.

[4] The rubber composition for a tire tread according to any one of [1] to [3], wherein the glass transition temperature of the thermoplastic elastomer is −35° C. or higher and 10° C. or lower.

[5] The rubber composition for a tire tread according to any one of [1] to [4], wherein the amount of the resin is 15 to 50 parts by mass based on 100 parts by mass of the diene rubber component.

[6] The rubber composition for a tire tread according to any one of [1] to [5], wherein the content ratio of the resin and the thermoplastic elastomer (the resin/the thermoplastic elastomer) is 1.5 or more as a mass ratio.

[7] A tire having a tread produced with the rubber composition according to any one of [1] to [6].

According to the rubber composition for a tire tread according to the embodiment of the invention, the balance of the wet performance, the rolling resistance performance, and the snow performance can be improved.

### BRIEF DESCRIPTION OF THE DRAWINGS

FIG. 1 is a tanδ-temperature curve of the rubber composition of Example 3.

### DESCRIPTION OF EMBODIMENTS

The rubber composition for a tire tread (also simply called “rubber composition” below) according to the embodiment of the invention contains a diene rubber component (A), a thermoplastic elastomer (B), a resin (C), and silica (D).

### ((A) Diene Rubber Component)

In the embodiment, the diene rubber component has a total styrene amount of less than 10 mass %. That is, the diene rubber component is composed of one diene rubber or a combination of diene rubbers in such a manner that the total styrene amount of the diene rubber component becomes less than 10 mass %. When the total styrene amount of the diene rubber component is less than 10 mass %, the glass transition temperature of the diene rubber component becomes low. In the embodiment, by combining a specific thermoplastic elastomer and a specific resin under the condition that such a diene rubber component is used, the balance of the snow performance, the wet performance, and the rolling resistance performance can be improved. The total styrene amount of the diene rubber component may be 0 mass % but is preferably more than 0 mass %, more preferably 1.0 to 9.5 mass %, further preferably 2.5 to 9.5 mass %, further preferably 5.0 to 9.5 mass %. Here, the diene rubber refers to a rubber having a repeating unit corresponding to a diene monomer having a conjugated double bond and has a double bond in the main chain of the polymer.

Here, the total styrene amount of the diene rubber component is the total amount (mass %) of the styrene unit contained in the total amount of the diene rubber component and is calculated by Σ(diene rubber content (mass %)×styrene amount (mass %) of the diene rubber/100). The diene rubber content (mass %) is the mass ratio of the diene rubber in 100 mass % of the diene rubber component. The styrene amount (mass %) of the diene rubber is determined by ¹H-NMR.

The diene rubber component preferably contains a styrene butadiene rubber (SBR). Examples of the SBR include a solution-polymerized styrene butadiene rubber (SSBR) and an emulsion-polymerized styrene butadiene rubber (ESBR). The SBR may be a modified styrene butadiene rubber in which the terminal, the main chain, or the like has been modified (modified SBR) or an unmodified styrene butadiene rubber without modification (unmodified SBR), or modified SBR and unmodified SBR may be used in combination. The SBR preferably contains a modified solution-polymerized styrene butadiene rubber (modified SSBR), and modified SSBR and unmodified SSBR may be used in combination. In this case, 100 mass % of the SBR preferably contains modified SBR (preferably modified SSBR) at 50 mass % or more, more preferably 60 mass % or more.

As the modified SBR (preferably modified SSBR), SBR which has been modified with a functional group that interacts with silica by introducing the functional group to the terminal and/or the main chain is used. The functional group preferably contains at least one selected from the group consisting of an oxygen atom, a nitrogen atom, and a silicon atom and more preferably contains an oxygen atom and/or a nitrogen atom. Specific examples of the functional group are at least one selected from the group consisting of an amino group, a hydroxy group, an amide group, an alkoxy group, a silyl group, an alkoxysilyl group, an epoxy group, and a carboxy group. When such modified SBR is used, the dispersibility of silica can be improved.

The diene rubber component may be composed of SBR alone but may contain another diene rubber. To adjust the total styrene amount to less than 10 mass %, a diene rubber containing no styrene unit is preferably used in combination as the other diene rubber. Examples of the other diene rubber include a natural rubber (NR), a synthetic isoprene rubber (IR), a butadiene rubber (BR), a nitrile rubber (NBR), a chloroprene rubber (CR), a styrene-isoprene copolymer rubber, a butadiene-isoprene copolymer rubber, and the like. Of these, at least one selected from the group consisting of NR, IR, and BR is preferably used, and BR is more preferably used.

In an embodiment, 100 parts by mass of the diene rubber component may contain 20 to 90 parts by mass of SBR, 10 to 80 parts by mass of BR, and 0 to 30 parts by mass of NR and/or IR, may contain 30 to 85 parts by mass of SBR, 15 to 70 parts by mass of BR, and 0 to 25 parts by mass of NR and/or IR, may contain 40 to 80 parts by mass of SBR, 20 to 50 parts by mass of BR, and 0 to 20 parts by mass of NR and/or IR, may contain 50 to 80 parts by mass of SBR, 20 to 40 parts by mass of BR, and 0 to 15 parts by mass of NR and/or IR, or may contain 60 to 80 parts by mass of SBR, 20 to 30 parts by mass of BR, and 0 to 15 parts by mass of NR and/or IR. Here, the amount of NR and/or IR may be 0 parts by mass or may be 5 parts by mass or more.

### ((B) Thermoplastic Elastomer)

A thermoplastic elastomer is added to the rubber composition according to the embodiment. By adding the thermoplastic elastomer, rolling resistance performance is easily improved.

As the thermoplastic elastomer, at least one styrene-based thermoplastic elastomer selected from the group consisting of a block copolymer of a styrene-based monomer and a diene monomer and a hydrogenated material thereof is used. The styrene-based thermoplastic elastomer is a block copolymer having a block derived from a styrene-based monomer as a hard segment and a block derived from a diene monomer as a soft segment and may be a hydrogenated material in which the diene moiety has been hydrogenated or a non-hydrogenated material which has not been hydrogenated. The thermoplastic elastomer is generally solid at normal temperature (25° C.), namely without fluidity. In the present specification, the thermoplastic elastomer (B) is not included in the diene rubber component (A) and the resin (C).

Examples of the styrene-based monomer include styrene, α-methylstyrene, p-methylstyrene, and the like, and styrene is preferable. Examples of the diene monomer include butadiene (namely, 1,3-butadiene), isoprene, and the like. Any one kind thereof may be used, or two or more kinds thereof may be used in combination.

Specific examples of the thermoplastic elastomer include a styrene-butadiene-styrene triblock copolymer (SBS) and a hydrogenated material thereof (SEBS), a styrene-isoprene-styrene triblock copolymer (SIS) and a hydrogenated material thereof (SEPS, SEEPS), a styrene-isoprene butadiene-styrene triblock copolymer and a hydrogenated material thereof, a styrene-butadiene diblock copolymer and a hydrogenated material thereof, a styrene-isoprene diblock copolymer and a hydrogenated material thereof, and the like. Any one kind thereof may be used, or two or more kinds thereof may be used in combination. The microstructure of the block derived from the diene monomer may be 1,4-bond or 1,2-bond, or both may be contained. Accordingly, for example, the SBS and the hydrogenated material thereof also include a styrene-vinylbutadiene-styrene triblock copolymer and a hydrogenated material thereof, and the SIS and the hydrogenated material thereof also include a styrene-vinylisoprene-styrene triblock copolymer and a hydrogenated material thereof. The styrene-isoprene butadiene-styrene triblock copolymer and the hydrogenated material thereof also include a styrene-vinylisoprene vinylbutadiene-styrene triblock copolymer and a hydrogenated material thereof.

As the constituent units, the styrene-based thermoplastic elastomer
has (a) a styrene unit derived from a styrene-based monomer and
can contain
(b1) at least one selected from the group consisting of an unsaturated 1,2-bond unit, an unsaturated 1,4-bond unit, a saturated ethylene unit, and a saturated butylene unit which are derived from butadiene
and/or
(b2) at least one selected from the group consisting of an unsaturated 1,2-bond unit, an unsaturated 3,4-bond unit, an unsaturated 1,4-bond unit, a saturated ethylene unit, a saturated propylene unit, and a saturated isopropylethylene (hydrogenated vinylisoprene) unit which are derived from isoprene.

In the embodiment, as the thermoplastic elastomer, a thermoplastic elastomer in which the amount of a butylene unit represented by —[CH₂—CH(C₂H₅)]— is 25 mass % or less based on the total mass of an ethylene unit represented by —(CH₂—CH₂)— and the butylene unit is used. When the butylene unit content is 25 mass % or less, the balance of the wet performance, the rolling resistance performance, and the snow performance can be improved. The butylene unit content may be 0 mass %, and for example, when butadiene is not contained as the diene monomer, the butylene unit content is 0 mass %, which means that no butylene unit is contained. Moreover, even when butadiene is contained as the diene monomer, in a non-hydrogenated material, the constituent units derived from butadiene are an unsaturated 1,2-bond unit and/or an unsaturated 1,4-bond unit, and thus no butylene unit is contained. The butylene unit content is preferably 0 to 22 mass %, more preferably 0 to 15 mass %, further preferably 0 to 10 mass %.

The styrene unit content of the thermoplastic elastomer is not particularly limited and may be, for example, 5 to 50 mass %, 8 to 45 mass %, or 10 to 40 mass %.

The butylene unit content, the ethylene unit content, and the styrene unit content of the thermoplastic elastomer are determined by the integral ratios of 1H-NMR.

The glass transition temperature (Tg) of the thermoplastic elastomer is preferably-35° C. or higher and 10° C. or lower. As a result, wet performance is easily maintained. The Tg of the thermoplastic elastomer is more preferably −35° C. to 0° C., more preferably −34° C. to −5° C., further preferably −33° C. to −10° C.

In the present specification, the glass transition temperature (Tg) is a value measured in accordance with JIS K7121:2012 by the differential scanning calorimetry (DSC) at a heating rate of 20° C./minute (measurement temperature range: −150° C. to 50° C.).

The thermoplastic elastomer content, based on 100 parts by mass of the diene rubber component, is 1 to 10 parts by mass, more preferably 3 to 9 parts by mass, more preferably 4 to 8 parts by mass. In the above range, the effect of the embodiment tends to be obtained more excellently.

### ((C) Resin)

At least one resin selected from the group consisting of a styrene-based resin and a hydrogenated petroleum resin is added to the rubber composition according to the embodiment. The resins are highly miscible with the diene rubber component and tend to decrease wet performance but improve rolling resistance performance and snow performance. On the other hand, the thermoplastic elastomer (B) tends to decrease the snow performance but improves the wet performance and the rolling resistance performance. Accordingly, by combining the thermoplastic elastomer (B) and the resin which is highly miscible therewith, the balance of the wet performance, the rolling resistance performance, and the snow performance can be improved.

A styrene-based resin is a resin obtained by polymerizing a styrene-based monomer as a constituent monomer and is a general term for resins including polymers of a styrene-based monomer and copolymers containing a styrene-based monomer as the main component (50 mass % or more). The styrene-based resin may be a homopolymer obtained by polymerizing one kind of styrene-based monomer alone, a copolymer obtained by copolymerizing two or more kinds of styrene-based monomer, or a copolymer of a styrene-based monomer and another monomer which can be copolymerized therewith. Examples of the styrene-based monomer include styrene, α-methylstyrene, p-methylstyrene, and the like.

Specific examples of the styrene-based resin include polystyrene, an α-methylstyrene homopolymer, a styrene/α-methylstyrene copolymer, a styrene-based monomer/aliphatic monomer copolymer, an α-methylstyrene/aliphatic monomer copolymer, a styrene-based monomer/α-methylstyrene/aliphatic monomer copolymer, and the like. Any one kind thereof may be used, or two or more kinds thereof may be used in combination. Of these, polystyrene, an α-methylstyrene homopolymer, and a styrene/α-methylstyrene copolymer are preferable.

The hydrogenated petroleum resin is a petroleum resin which has been hydrogenated and includes a partially hydrogenated petroleum resin. Examples of the petroleum resin include an aliphatic petroleum resin (C5-based petroleum resin), an aromatic petroleum resin (C9-based petroleum resin), and an aliphatic/aromatic copolymer petroleum resin (C5/C9-based petroleum resin). Any one kind thereof may be used, or two or more kinds thereof may be used in combination.

C5-based petroleum resin is a resin obtained by cationic polymerization of an unsaturated monomer which is a petroleum fraction with four to five carbon atoms (C5 fraction), such as isoprene and cyclopentadiene. C9-based petroleum resin is a resin obtained by cationic polymerization of a monomer which is a petroleum fraction with eight to 10 carbon atoms (C9 fraction), such as vinyltoluene, alkylstyrene, and indene. C5/C9-based petroleum resin is a resin obtained by copolymerizing C5 fraction and C9 fraction by cationic polymerization.

The softening points of the styrene-based resin and the hydrogenated petroleum resin are not particularly limited and are, for example, preferably 50° C. to 160° C., more preferably 70° C. to 150° C., further preferably 80° C. to 140° C. Here, the softening points are measured in accordance with JIS K6220-1:2001 using a ring-and-ball softening point tester.

The resin content, based on 100 parts by mass of the diene rubber component, is preferably 15 to 50 parts by mass, more preferably 25 to 45 parts by mass, further preferably 28 to 40 parts by mass. In the above range, the effect of the embodiment tends to be obtained more excellently.

The content ratio of the resin (C) and the thermoplastic elastomer (B) (the resin/the thermoplastic elastomer) is preferably 1.5 or more as a mass ratio. When the resin/the thermoplastic elastomer is 1.5 or more, the balance of the wet performance, the rolling resistance performance, and the snow performance is further improved easily. The resin/the thermoplastic elastomer is more preferably 2 to 15, more preferably 3 to 10, further preferably 3.5 to 8.

### ((D) Silica)

Silica is used as a reinforcing filler in the rubber composition according to the embodiment. The silica is not particularly limited, and for example, wet silica such as wet-precipitated silica and wet-gelled silica may be used.

The nitrogen adsorption specific surface area of the silica is not particularly limited and may be, for example, 100 to 300 m²/g. The nitrogen adsorption specific surface area is preferably 120 to 270 m²/g, more preferably 150 to 250 m²/g, further preferably 160 to 240 m²/g. Here, the nitrogen adsorption specific surface area of the silica is the BET specific surface area measured in accordance with the BET method described in JIS K6430:2008.

The silica content, based on 100 parts by mass of the diene rubber component, is preferably 100 to 180 parts by mass, more preferably 105 to 150 parts by mass, further preferably 120 to 140 parts by mass. In the above range, the effect of the embodiment tends to be obtained more excellently.

The rubber composition according to the embodiment preferably contains a silane coupling agent. Examples of the silane coupling agent include sulfide silane coupling agents such as bis(3-triethoxysilylpropyl) tetrasulfide, bis(2-triethoxysilylethyl)tetrasulfide, bis(4-triethoxysilylbutyl)tetrasulfide, bis(3-trimethoxysilylpropyl) tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl) disulfide, bis(2-triethoxysilylethyl)disulfide, bis(4-triethoxysilylbutyl)disulfide, bis(3-trimethoxysilylpropyl) disulfide, trimethoxysilylbutyl)disulfide, bis(2-trimethoxysilylethyl)disulfide, bis(4-3-trimethoxysilylpropyl-N,N-dimethylthiocarbamoyltetrasulfide, 2-triethoxysilylethyl-N,N-dimethylthiocarbamoyltetrasulfide, and 3-triethoxysilylpropyl methacrylate monosulfide, mercapto silane coupling agents such as 3-mercaptopropyltrimethoxysilane, 2-mercaptoethyltriethoxysilane, “NXT” (3-octanoylthio-1-propyltriethoxysilane) manufactured by Momentive Performance Materials, “NXT Z45” manufactured by Momentive Performance Materials, and “VP Si363” formula: HS—(CH₂)₃—Si(OC₂H₅)ₘ(O(C₂H₄O)ₖ—C₁₃H₂₇)ₙ (in the formula, m=1 in the average, n=2 in the average, and k=5 in the average) manufactured by Evonik Degussa Corporation, and the like. Any one kind thereof may be used, or two or more kinds thereof may be used in combination. Of these, a thioester group-containing silane coupling agent having a thioester bond (—S—CO—) in which the mercapto group (—SH) is blocked, such as 3-octanoylthio-1-propyltriethoxysilane, is preferable for enhancing the effect of the embodiment.

When the silane coupling agent is contained, the content thereof based on the silica content is preferably 3 to 20 mass %, more preferably 5 to 15 mass %.

### (Other Components)

An additive which is generally used for a rubber composition, such as a filler other than silica, an oil, zinc oxide, stearic acid, a wax, a processing aid, an antioxidant, a vulcanizing agent, and a vulcanization accelerator, can be added to the rubber composition according to the embodiment in addition to the above components.

An example of the filler other than silica is carbon black. The carbon black is not particularly limited, and various known kinds can be used. The carbon black content is not particularly limited, and when the carbon black is used for coloring or the like, for example, the carbon black content may be, based on 100 parts by mass of the diene rubber component, 10 parts by mass or less or 1 to 10 parts by mass.

The oil content is not particularly limited and may be, for example, based on 100 parts by mass of the diene rubber component, 0 to 40 parts by mass, 5 to 40 parts by mass, or 10 to 35 parts by mass. Here, when an oil extended rubber is used as the diene rubber, the oil content contains the amount of the oil contained in the oil extended rubber.

The zinc oxide content is not particularly limited and may be, for example, based on 100 parts by mass of the diene rubber component, 0 to 10 parts by mass, 0.5 to 5 parts by mass, or 1 to 4 parts by mass.

The stearic acid content is not particularly limited and may be, for example, based on 100 parts by mass of the diene rubber component, 0 to 10 parts by mass, 0.5 to 5 parts by mass, or 1 to 4 parts by mass.

The wax content is not particularly limited and may be, for example, based on 100 parts by mass of the diene rubber component, 0 to 10 parts by mass, 0.5 to 5 parts by mass, or 1 to 4 parts by mass.

The processing aid content is not particularly limited and may be, for example, based on 100 parts by mass of the diene rubber component, 0 to 10 parts by mass, 0.5 to 5 parts by mass, or 1 to 4 parts by mass.

Examples of the antioxidant include various antioxidants such as amine-ketone-based, aromatic secondary amine-based, monophenol-based, bisphenol-based, and benzimidazole-based antioxidants, and any one kind thereof or a combination of two or more kinds thereof can be used. The antioxidant content is not particularly limited and may be, for example, based on 100 parts by mass of the diene rubber component, 0 to 10 parts by mass, 0.5 to 5 parts by mass, or 1 to 4 parts by mass.

As the vulcanizing agent, sulfur is preferably used. The vulcanizing agent content is not particularly limited and may be, based on 100 parts by mass of the diene rubber component, 0.1 to 10 parts by mass, 0.5 to 5 parts by mass, or 1 to 3 parts by mass.

Examples of the vulcanization accelerator include various vulcanization accelerators such as sulfenamide-based, guanidine-based, thiuram-based, and thiazole-based vulcanization accelerators, and any one kind thereof alone or a combination of two or more kinds thereof can be used. The vulcanization accelerator content is not particularly limited and may be, based on 100 parts by mass of the diene rubber component, 0.1 to 10 parts by mass, 1 to 7 parts by mass, or 2 to 5 parts by mass.

### (Rubber Composition for Tire Tread)

In the rubber composition according to the embodiment, the peak temperature of the diene rubber component is preferably −20° C. or lower in a tanδ-temperature curve of the rubber composition which has been vulcanized obtained by a dynamic viscoelasticity test by a tension method with a frequency of 10 Hz, a static strain of 10%, and a strain amplitude of 0.2% in accordance with JIS K6394:2007. When the peak temperature of the diene rubber component is −20° C. or lower, snow performance which is suitable for application to winter tires, all-season tires, and the like can be obtained. The peak temperature of the diene rubber component is more preferably −50° C. to −23° C., further preferably −45° C. to −25° C., further preferably −40° C. to −30° C. Here, the peak temperature of the diene rubber component in the tanδ-temperature curve can be adjusted mainly with the composition of the diene rubber component.

The rubber composition according to the embodiment can be produced by kneading using a generally used mixer such as a Banbury mixer, a kneader, and a roll according to a general method. That is, for example, the additives excluding the vulcanizing agent and the vulcanization accelerator are added to and mixed in the diene rubber component in a first mixing stage. Next, the vulcanizing agent and the vulcanization accelerator are added to and mixed in the obtained mixture in a final mixing stage, and thus a rubber composition can be prepared.

The rubber composition obtained in this manner can be used for the tread of a tire. Examples of the tire include pneumatic tires of various sizes for various applications, such as tires of passenger vehicles and large-sized tires of trucks and buses. The rubber composition is preferably used for the tread of a winter tire or an all-season tire because of the excellent snow performance.

The tire according to an embodiment has a tread produced using the rubber composition. That is, the tire according to an embodiment has a tread rubber formed from the rubber composition. The structures of the tread rubber of a tire include a two-layer structure having a cap rubber and a base rubber and a single-layer structure in which both are combined. In the single-layer structure, the tread rubber may be formed with the rubber composition. In the two-layer structure, although the cap rubber on the outer side which comes into contact with the road surface is preferably formed with the rubber composition, the base rubber placed inside the cap rubber may be formed with the rubber composition, and both the cap rubber and the base rubber may be formed with the rubber composition.

The production method of the tire is not particularly limited. For example, the rubber composition is formed into a predetermined form by extrusion processing according to a general method, and an unvulcanized tread rubber member is obtained. By assembling the tread rubber member with other tire members, an unvulcanized tire (green tire) is produced. Then, for example, by vulcanizing and forming at 140° C. to 180° C., a tire can be produced.

### EXAMPLES

Examples of the invention are shown below, but the invention is not limited to these Examples.

The components used in the Examples and the Comparative Examples are as follows.
SBR-1: terminal-modified SSBR, styrene amount=10 mass %, “HPR840” manufactured by ENEOS Materials Corporation.
SBR-2: unmodified SSBR, styrene amount=17 mass %, “Tufdene 1834” manufactured by Asahi Kasei Corporation, an oil extended product of 37.5 parts by mass based on 100 parts by mass of rubber content
SBR-3: terminal-modified SSBR, styrene amount=27.5 mass %, “HPR850” manufactured by ENEOS Materials Corporation.
BR: Nd-BR, “Buna CB22” manufactured by Lanxess
NR: RSS #3
Carbon black: HAF-HS, “Seast KH” manufactured by TOKAI CARBON CO., LTD.
Silica-1: nitrogen adsorption specific surface area=125 m²/g, “Ultrasil VN2” manufactured by Evonik Corporation
Silica-2: nitrogen adsorption specific surface area=180 m²/g, “Ultrasil VN3” manufactured by Evonik Corporation.
Silica-3: nitrogen adsorption specific surface area=230 m²/g, “9100GR” manufactured by Evonik Corporation
Coupling agent-1: sulfide-based, “Si69” manufactured by Evonik Corporation
Coupling agent-2: mercapto-based, “NXT” manufactured by Momentive Performance Materials
Oil: “Process NC140” manufactured by ENEOS Corporation Resin-1: terpene resin, softening point=115° C., “SYLVATRAXX 4150” manufactured by Kraton Corporation
Resin-2: non-hydrogenated C5-based petroleum resin, softening point=100° C., “HHC-1100” manufactured by Henghe Materials & Science Technology Co., Ltd.
Resin-3: styrene-based resin, softening point=85° C., “SYLVATRAXX 4401” manufactured by Kraton Corporation
Resin-4: hydrogenated C5/C9-based petroleum resin, softening point=103° C., “Oppera PR-383” manufactured by Exxon Mobil Corporation
Resin-5: partially hydrogenated C9-based petroleum resin, softening point=90° C., “HM-900” manufactured by Henghe Materials & Science Technology Co., Ltd.
Resin-6: partially hydrogenated C9-based petroleum resin, softening point=100° C., “HM-1000” manufactured by Henghe Materials & Science Technology Co., Ltd.
Resin-7: partially hydrogenated C9-based petroleum resin, softening point=140° C., “HM-1400” manufactured by Henghe Materials & Science Technology Co., Ltd.
Resin-8: hydrogenated C5-based petroleum resin, softening point=100° C., “H5-1002” manufactured by Henghe Materials & Science Technology Co., Ltd.
Resin-9: partially hydrogenated C5-based petroleum resin, softening point=100° C., “H5-1000W” manufactured by Henghe Materials & Science Technology Co., Ltd.
TPE-1: a hydrogenated material of a styrene-butadiene-styrene triblock copolymer (SEBS), styrene unit content=40 mass %, butylene unit content based on total mass of butylene unit and ethylene unit=4 mass %, Tg=−24° C., “S.O.E. S1606” manufactured by Asahi Kasei Corporation
TPE-2: a hydrogenated material of a styrene-vinylisoprene-styrene triblock copolymer, styrene unit content-20 mass %, butylene unit content=0 mass %, Tg=−15° C., “Hybrar 7125F” manufactured by Kuraray Co., Ltd.
TPE-3: a hydrogenated material of a styrene-vinylisoprene vinylbutadiene-styrene triblock copolymer, styrene unit content=12 mass %, butylene unit content based on total mass of butylene unit and ethylene unit=20 mass %, Tg=−32° C., “Hybrar 7311F” manufactured by Kuraray Co., Ltd.
TPE-4: a styrene-vinylisoprene-styrene triblock copolymer (non-hydrogenated), styrene unit content=20 mass %, butylene unit content-0 mass %, Tg−8° C., “Hybrar 5127” manufactured by Kuraray Co., Ltd.
TPE-5: a hydrogenated material of a styrene-butadiene-styrene triblock copolymer (SEBS), styrene unit content=28 mass %, butylene unit content=39 mass %, Tg=−47° C., “SEPTON8004” manufactured by Kuraray Co., Ltd.
Zinc oxide: “Zinc Oxide, Type 2” manufactured by MITSUI MINING & SMELTING CO., LTD.
Stearic acid: “Beads Stearic Acid” manufactured by NOF CORPORATION
Wax: “OZOACE0355” manufactured by NIPPON SEIRO CO., LTD.
Processing aid: “Aktiplast PP” manufactured by Lanxess
Antioxidant: “Nocrac 6C” manufactured by OUCHI SHINKO CHEMICAL INDUSTRIAL CO., LTD.
Vulcanization accelerator-1: “Nocceler D” manufactured by OUCHI SHINKO CHEMICAL INDUSTRIAL CO., LTD.
Vulcanization accelerator-2: “Nocceler CZ-G (CZ)” manufactured by OUCHI SHINKO CHEMICAL INDUSTRIAL CO., LTD.
Sulfur: “Powder Sulfur” manufactured by Tsurumi Chemical Industry Co., ltd.

Using a Banbury mixer, in accordance with the composition (parts by mass) shown in Tables 1 to 3 below, first, the agents to be added excluding sulfur and the vulcanization accelerators were added to and kneaded in the diene rubber component in a first mixing stage (discharge temperature=155° C.). Next, sulfur and the vulcanization accelerators were added to and kneaded in the obtained kneaded material in a final mixing stage (discharge temperature=90° C.), and each rubber composition was thus prepared. In the tables, the amounts of SBR-2 in the parentheses are the amounts as the rubber contents. The styrene amounts in the tables are the total styrene amounts of the diene rubber components.

The peak temperature of the diene rubber component of each rubber composition obtained was determined, and snow performance, rolling resistance performance, and wet performance were evaluated. The measurement methods and the evaluation methods are as follows.

### (1) Peak Temperature of Diene Rubber Component

A dynamic viscoelasticity test in accordance with JIS K6394:2007 was conducted. Specifically, a rubber composition was vulcanized at 170° C. for 15 minutes, and a test piece having a width of 5 mm, a thickness of 2 mm, and a length of 30 mm was produced. Using the test piece, a dynamic viscoelasticity test by a tension method with a frequency of 10 Hz, a static strain of 10%, and a strain amplitude of 0.2% was conducted with a chuck distance of 20 mm. From the obtained tanδ-temperature curve, the peak temperature (the temperature of the peak top) of the diene rubber component was determined. In the tables, the peak temperatures of the diene rubber components are shown in “tanδ (rubber)”.

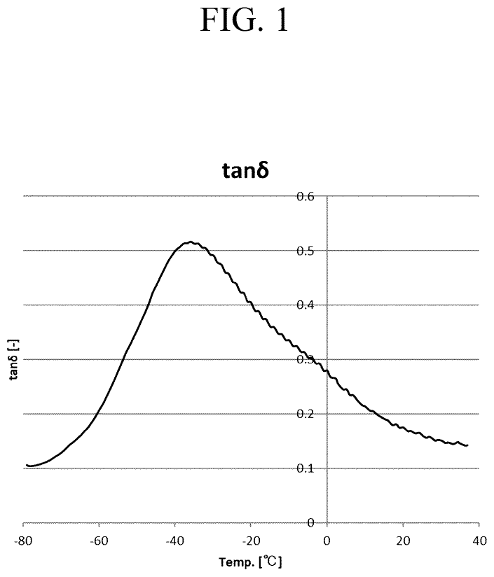

As an example, FIG. 1 is a tanδ-temperature curve of the rubber composition of Example 3. The peak temperature of the diene rubber component read from the temperature curve shown in FIG. 1 is −35° C.

### (2) Snow Performance

Radial tires for testing (tire size: 215/45ZR17) were produced using a rubber composition for the tread rubber by vulcanizing and forming according to a normal method. Four of the obtained tires were mounted on a vehicle. The vehicle was driven on a snowy road at 60 km per hour under the condition of an air temperature of −10° C., and the braking distance after activating the ABS from the above state and reducing the speed to 20 km per hour was measured. The reciprocal of the measured value was calculated and expressed with an index, where the calculated value of Comparative Example 1 was regarded as 100. As the index becomes larger, the braking distance becomes shorter, meaning that snow braking performance is excellent.

### (3) Rolling Resistance Performance (RR Performance)

Rolling resistance of each radial tire for testing obtained above was measured with a rolling resistance-measuring drum under the conditions of an air pressure of 230 kPa, a load of 450 kgf (4.4 kN), at 23° C., and 80 km/h, and the reciprocal of the rolling resistance was expressed with an index, where the value of Comparative Example 1 was regarded as 100. As the index becomes larger, the rolling resistance becomes smaller, meaning that rolling resistance performance is excellent.

### (4) Wet Performance

Four of the radial tires for testing above were mounted on a vehicle, and the vehicle was driven on a road surface to which water was spread to a water depth of 2 to 3 mm under the condition of an air temperature of 25° C. The abrasion resistance was measured at a speed of 100 km per hour, and wet grip performance was evaluated. The value was expressed with an index, where the abrasion resistance value of Comparative Example 1 was regarded as 100. As the index becomes larger, the abrasion resistance becomes larger, meaning that the wet performance is excellent.

TABLE 1

| | Comp. | Comp. | Comp. | Comp. | Comp. | Comp. | | | |
|---|---|---|---|---|---|---|---|---|---|
| | Ex. 1 | Ex. 2 | Ex. 3 | Ex. 4 | Ex. 5 | Ex. 6 | Ex. 1 | Ex. 2 | Ex. 3 |
| Composition (parts by mass) | | | | | | | | | |
| SBR-1 | 50 | 50 | 50 | 50 | 50 | 40 | 50 | 50 | 50 |
| SBR-2 | 34.375 | 34.375 | 34.375 | 34.375 | 34.375 | | 34.375 | 34.375 | 34.375 |
| | [25] | [25] | [25] | [25] | (25) | | [25] | [25] | [25] |
| SBR-3 | | | | | | 10 | | | |
| BR | 25 | 25 | 25 | 25 | 25 | 40 | 25 | 25 | 25 |
| NR | | | | | | 10 | | | |
| Carbon black | 5 | 5 | 5 | 5 | 5 | 5 | 5 | 5 | 5 |
| Silica-1 | | | | | | | 125 | | |
| Silica-2 | 105 | 125 | 125 | 125 | 125 | 125 | | 125 | 125 |
| Silica-3 | | | | | | | | | |
| Coupling agent-1 | 8.4 | | | | | 10 | | | |
| Coupling agent-2 | | 10 | 10 | 10 | 10 | | 7.5 | 10 | 10 |
| Oil | 10.625 | 20.625 | 17.625 | 3.825 | 27.625 | 34 | 10.625 | 10.625 | 10.625 |
| Resin-1 | 30 | 30 | | | | | | | |
| Resin-2 | | | 30 | | | | | | |
| Resin-3 | | | | | | | | 30 | |
| Resin-4 | | | | 30 | 50 | 30 | 30 | | 30 |
| Resin-5 | | | | | | | | | |
| Resin-6 | | | | | | | | | |
| Resin-7 | | | | | | | | | |
| Resin-8 | | | | | | | | | |
| Resin-9 | | | | | | | | | |
| TPE-1 | | 7 | 7 | 11 | | | 7 | 7 | 7 |
| TPE-2 | | | | | | | | | |
| TPE-3 | | | | | | | | | |
| TPE-4 | | | | | | | | | |
| TPE-5 | | | | | | 10 | | | |
| Zinc oxide | 2 | 2 | 2 | 2 | 2 | 2 | 2 | 2 | 2 |
| Stearic acid | 2 | 2 | 2 | 2 | 2 | 2 | 2 | 2 | 2 |
| Wax | 2 | 2 | 2 | 2 | 2 | 2 | 2 | 2 | 2 |
| Processing aid | 2 | 2 | 2 | 2 | 2 | 2 | 2 | 2 | 2 |
| Antioxidant | 2 | 2 | 2 | 2 | 2 | 2 | 2 | 2 | 2 |
| Vulcanization accelerator-1 | 2.5 | 2.5 | 2.5 | 2.5 | 2.5 | 2.5 | 2.3 | 2.5 | 2.5 |
| Vulcanization accelerator-2 | 2 | 2 | 2 | 2 | 2 | 2 | 2 | 2 | 2 |
| Sulfur | 1.5 | 1.5 | 1.5 | 1.5 | 1.5 | 1.5 | 1.5 | 1.5 | 1.5 |
| Styrene amount [mass %] | 9.3 | 9.3 | 9.3 | 9.3 | 9.3 | 6.8 | 9.3 | 9.3 | 9.3 |
| tanδ (rubber) [° C.] | −36 | −35 | −36 | −35 | −24 | −29 | −35 | −36 | −35 |
| Snow performance [index] | 100 | 77 | 89 | 88 | 110 | 95 | 110 | 117 | 109 |
| RR performance [index] | 100 | 110 | 111 | 109 | 90 | 106 | 116 | 117 | 114 |
| Wet performance [index] | 100 | 100 | 100 | 100 | 101 | 100 | 100 | 100 | 101 |

TABLE 2

| | Ex. 4 | Ex. 5 | Ex. 6 | Ex. 7 | Ex. 8 | Ex. 9 | Ex. 10 | Ex. 11 | Ex. 12 |
|---|---|---|---|---|---|---|---|---|---|
| Composition (parts by mass) | | | | | | | | | |
| SBR-1 | 50 | 50 | 50 | 50 | 50 | 50 | 50 | 50 | 50 |
| SBR-2 | 34.375 | 34.375 | 34.375 | 34.375 | 34.375 | 34.375 | 34.375 | 34.375 | 34.375 |
| | [25] | [25] | [25] | [25] | [25] | [25] | [25] | [25] | [25] |
| SBR-3 | | | | | | | | | |
| BR | 25 | 25 | 25 | 25 | 25 | 25 | 25 | 25 | 25 |
| NR | | | | | | | | | |
| Carbon black | 5 | 5 | 5 | 5 | 5 | 5 | 5 | 5 | 5 |
| Silica-1 | | | | | | | | | |
| Silica-2 | 125 | 125 | 125 | 125 | 125 | 125 | 125 | 125 | 125 |
| Silica-3 | | | | | | | | | |
| Coupling agent-1 | | | | | | | | | |
| Coupling agent-2 | 10 | 10 | 10 | 10 | 10 | 10 | 10 | 10 | 10 |
| Oil | 10.625 | 10.625 | 19.625 | 10.625 | 10.625 | 10.625 | 22.625 | 20.625 | 10.625 |
| Resin-1 | | | | | | | | | |
| Resin-2 | | | | | | | | | |
| Resin-3 | | | | | | | | | |
| Resin-4 | | | | | | | 15 | 20 | 30 |
| Resin-5 | 35 | | | | | 15 | | | |
| Resin-6 | | 30 | | | | | | | |
| Resin-7 | | | 25 | | | 15 | | | |
| Resin-8 | | | | 30 | | | | | |
| Resin-9 | | | | | 30 | | | | |
| TPE-1 | 7 | 7 | 5 | 7 | 7 | 7 | | | |
| TPE-2 | | | | | | | 5 | | |
| TPE-3 | | | | | | | | 5 | |
| TPE-4 | | | | | | | | | 7 |
| TPE-5 | | | | | | | | | |
| Zinc oxide | 2 | 2 | 2 | 2 | 2 | 2 | 2 | 2 | 2 |
| Stearic acid | 2 | 2 | 2 | 2 | 2 | 2 | 2 | 2 | 2 |
| Wax | 2 | 2 | 2 | 2 | 2 | 2 | 2 | 2 | 2 |
| Processing aid | 2 | 2 | 2 | 2 | 2 | 2 | 2 | 2 | 2 |
| Antioxidant | 2 | 2 | 2 | 2 | 2 | 2 | 2 | 2 | 2 |
| Vulcanization accelerator-1 | 2.5 | 2.5 | 2.5 | 2.5 | 2.5 | 2.5 | 2.5 | 2.5 | 2.5 |
| Vulcanization accelerator-2 | 2 | 2 | 2 | 2 | 2 | 2 | 2 | 2 | 2 |
| Sulfur | 1.5 | 1.5 | 1.5 | 1.5 | 1.5 | 1.5 | 1.5 | 1.5 | 1.5 |
| Styrene amount [mass %] | 9.3 | 9.3 | 9.3 | 9.3 | 9.3 | 9.3 | 9.3 | 9.3 | 9.3 |
| tanδ (rubber) [° C.] | −36 | −35 | −35 | −36 | −36 | −36 | −37 | −36 | −35 |
| Snow performance [index] | 110 | 114 | 108 | 111 | 109 | 108 | 109 | 109 | 109 |
| RR performance [index] | 115 | 116 | 116 | 117 | 116 | 116 | 117 | 118 | 106 |
| Wet performance [index] | 100 | 100 | 100 | 100 | 100 | 100 | 100 | 100 | 100 |

TABLE 3

| | Ex. 13 | Ex. 14 | Ex. 15 | Ex. 16 | Ex. 17 | Ex. 18 | Ex. 19 | Ex. 20 |
|---|---|---|---|---|---|---|---|---|
| Composition (parts by mass) | | | | | | | | |
| SBR-1 | 50 | 50 | 50 | 50 | 50 | 40 | 40 | 30 |
| SBR-2 | 34.375 | 34.375 | 34.375 | 34.375 | 34.375 | | | |
| | [25] | [25] | [25] | [25] | [25] | | | |
| SBR-3 | | | | | | 10 | 10 | |
| BR | 25 | 25 | 25 | 25 | 25 | 40 | 40 | 70 |
| NR | | | | | | 10 | 10 | |
| Carbon black | 5 | 5 | 5 | 5 | 5 | 5 | 5 | 5 |
| Silica-1 | | | | | | | | |
| Silica-2 | 125 | 125 | 125 | 125 | | 135 | 135 | 120 |
| Silica-3 | | | | | 125 | | | |
| Coupling agent-1 | | | | 8.4 | | | | |
| Coupling agent-2 | 10 | 10 | 10 | | 13.75 | 10.8 | 10.8 | 9.6 |
| Oil | 10.625 | 13.625 | 12.625 | 10.625 | 10.625 | 34 | 34 | |
| Resin-1 | | | | | | | | |
| Resin-2 | | | | | | | | |
| Resin-3 | | | | | | | | |
| Resin-4 | 35 | 30 | 30 | 40 | 30 | 30 | | 30 |
| Resin-5 | | | | | | | | |
| Resin-6 | | | | | | | 30 | |
| Resin-7 | | | | | | | | |
| Resin-8 | | | | | | | | |
| Resin-9 | | | | | | | | |
| TPE-1 | 5 | 3 | 9 | 5 | 7 | 7 | 7 | 7 |
| TPE-2 | | | | | | | | |
| TPE-3 | | | | | | | | |
| TPE-4 | | | | | | | | |
| TPE-5 | | | | | | | | |
| Zinc oxide | 2 | 2 | 2 | 2 | 2 | 2 | 2 | 2 |
| Stearic acid | 2 | 2 | 2 | 2 | 2 | 2 | 2 | 2 |
| Wax | 2 | 2 | 2 | 2 | 2 | 2 | 2 | 2 |
| Processing aid | 2 | 2 | 2 | 2 | 2 | 2 | 2 | 2 |
| Antioxidant | 2 | 2 | 2 | 2 | 2 | 2 | 2 | 2 |
| Vulcanization accelerator-1 | 2.5 | 2.5 | 2.5 | 2.5 | 2.8 | 2.8 | 2.8 | 2.8 |
| Vulcanization accelerator-2 | 2 | 2 | 2 | 2 | 2 | 2 | 2 | 2 |
| Sulfur | 1.5 | 1.5 | 1.5 | 1.5 | 1.5 | 1.5 | 1.5 | 1.5 |
| Styrene amount [mass %] | 9.3 | 9.3 | 9.3 | 9.3 | 9.3 | 6.8 | 6.8 | 3.0 |
| tanδ (rubber) [° C.] | −35 | −35 | −35 | −34 | −35 | −29 | −20 | −46 |
| Snow performance [index] | 105 | 116 | 107 | 104 | 108 | 109 | 114 | 119 |
| RR performance [index] | 117 | 110 | 116 | 113 | 114 | 116 | 117 | 103 |
| Wet performance [index] | 100 | 101 | 100 | 101 | 101 | 101 | 100 | 102 |

The results are as shown in Tables 1 to 3. Comparative Example 1 is a control composition in which the silica amount was 105 parts by mass and which used a sulfide silane coupling agent, contained a terpene resin having excellent wet performance and did not contain any thermoplastic elastomer. Compared to Comparative Example 1, in Comparative Example 2, in which the silica amount was increased, and which used a mercapto silane coupling agent and contained a thermoplastic elastomer, the rolling resistance performance improved, but the snow performance deteriorated significantly because the resin was a terpene resin. In Comparative Example 3, although the terpene resin of Comparative Example 2 was replaced with a non-hydrogenated petroleum resin, the rolling resistance performance improved, but the snow performance deteriorated as in Comparative Example 2.

In Comparative Example 4, because the amount of the thermoplastic elastomer was higher than the specific amount although a hydrogenated petroleum resin was used as the resin, the rolling resistance performance improved, but the snow performance deteriorated. In Comparative Example 5, the resin amount was increased while the thermoplastic elastomer was not added compared with Comparative Example 4, and the snow performance was improved, but the rolling resistance performance deteriorated. In Comparative Example 6, because a thermoplastic elastomer having a high butylene unit content was used, the rolling resistance performance was excellent, but the snow performance deteriorated.

On the contrary, in Examples 1 to 20, while the excellent wet performance of Comparative Example 1 was maintained, the snow performance and the rolling resistance performance were both improved, and the issue that the wet performance, the snow performance, and the rolling resistance performance conflicted each other was improved. That is, the balance of the wet performance, the snow performance, and the rolling resistance performance was improved.

In this regard, the upper limits and the lower limits of the various numerical ranges described in the specification can be combined freely, and all the combinations should be regarded as being described as preferable numerical ranges in the present specification. Moreover, a numerical range “X to Y” means X or more and Y or less.

What is claimed is:

1. A rubber composition for a tire tread, comprising:
a diene rubber component having a total styrene amount of less than 10 mass %;
at least one thermoplastic elastomer selected from the group consisting of a block copolymer of a styrene-based monomer and a diene monomer and a hydrogenated material thereof, wherein the amount of a butylene unit represented by —[CH₂—CH(C₂H₅)]— is 25 mass % or less based on the total mass of an ethylene unit represented by —(CH₂—CH₂)— and the butylene unit;
at least one resin selected from the group consisting of a styrene-based resin and a hydrogenated petroleum resin; and
silica:
wherein the amount of the thermoplastic elastomer based on 100 parts by mass of the diene rubber component is 1 to 10 parts by mass.

2. The rubber composition for a tire tread according to claim 1, wherein the diene rubber component contains a styrene butadiene rubber.

3. The rubber composition for a tire tread according to claim 2, wherein the styrene butadiene rubber contains a modified styrene butadiene rubber.

4. The rubber composition for a tire tread according to claim 1, wherein 100 parts by mass of the diene rubber component contain 20 to 90 parts by mass of a styrene butadiene rubber, 10 to 80 parts by mass of a butadiene rubber, and 0 to 30 parts by mass of a natural rubber and/or a synthetic isoprene rubber.

5. The rubber composition for a tire tread according to claim 1, wherein the peak temperature of the diene rubber component is −20° C. or lower in a tanδ-temperature curve of the rubber composition which has been vulcanized obtained by a dynamic viscoelasticity test by a tension method with a frequency of 10 Hz, a static strain of 10%, and a strain amplitude of 0.2% in accordance with JIS K6394:2007.

6. The rubber composition for a tire tread according to claim 1, wherein the glass transition temperature of the thermoplastic elastomer is −35° C. or higher and 10° C. or lower.

7. The rubber composition for a tire tread according to claim 1, wherein the amount of the resin is 15 to 50 parts by mass based on 100 parts by mass of the diene rubber component.

8. The rubber composition for a tire tread according to claim 1, wherein the content ratio of the resin and the thermoplastic elastomer (the resin/the thermoplastic elastomer) is 1.5 or more as a mass ratio.

9. A tire comprising a tread produced with the rubber composition according to claim 1.
